(19) United States
(12) Patent Application Publication
(10) Pub. No.: US 2007/0294124 A1
(43) Pub. Date: Dec. 20, 2007

(54) Hospitality performance index

(76) Inventors: John Charles Crotts, Mt. Pleasant, SC (US); Wayne Jeffrey Staats, Cedar Rapids, IA (US)

Correspondence Address: KATHLEEN M HARLESTON;THE HARLESTON LAW FIRM, 909 TALL PINE ROAD, MT PLEASANT, SC, 29464, US

(21) Appl. No.: 11/452,517

(22) Filed: Jun. 14, 2006

(51) Int. Cl. G06F 17/30

(52) U.S. Cl. 705/10

(57) ABSTRACT

A method for evaluating and forecasting performance at a hospitality facility in a hospitality performance system, including the steps of: (1) transmitting each subject hospitality facility's performance data to a central service of the hospitality performance system using an Internet browser to access a system website, the central service being in communication with each of the hospitality facilities; (2) analyzing performance data submitted by the hospitality facilities using the central service; and (3) storing the performance analyses so that they are retrievable anytime by the system hospitality facilities. The first step preferably includes the following steps: a) using a personal computer and a pre-assigned password to log onto the system website; b) accessing a weekly questionnaire from the system website; c) completing the questionnaire; and d) submitting the completed questionnaire. A performance report can be printed out for the hospitality facility, which may be a lodging facility, a food and beverage outlet, and/or a visitor attraction.

### BACKGROUND OF THE INVENTION

1. Technical Field

The present invention relates to a system and method for performance evaluation and improving business performance of a lodging facility, food and beverage outlet, visitor attraction, or the like, and forecasting future attendance and other patterns for the particular lodging facility, food and beverage outlet, or visitor attraction based on computer-generated patterns for an aggregate of like facilities in the particular region.

2. Background Information

In contrast with commercially available surveys from a third party consultant, who gathers information and compares a client's facility's past performance with its competitive set, the Internet-based, computerized system of the present invention is a readily accessible, user-friendly system accessible from the user's own computer at the user's convenience. The hospitality performance system of the present invention permits a hotelier, restauranteur, attraction owner, or other system user to compare his or her property's performance for the previous week with a choice of other lodging segments or the like based on a selected parameter, such as type, location, or rate. This allows the hotelier system user, for example, to compare and contrast the subject facility's performance with the full market as well as any other aggregated lodging segment of their choice in their region. The present performance system also allows the hotelier, restauranteur, attraction owner, or other user to compare forecasted anticipated bookings for the subject facility by day for the next four weeks with other lodging aggregates or the like, which permits the user to benchmark the subject facility's future performance in the marketplace. In addition, the present invention allows the system user to retrieve and analyze historical data to identify trends in demands, which is useful in forecasting future customer demand. With the performance system of the present invention, such information can be accessed within a few minutes at any time of the day or night. The system user can pick and choose the segments with which to contrast the subject facility's performance and future booking patterns. The present system also automatically produces a customized report for the user, which the user can forward to his or her supervisors, etc.

Information generated by the present system can help the hotelier or other system user to make informed business decisions and therefore better serve guests and increase overall performance of the property. This is true whether the present performance system is used to analyze data and provide forecasts for a particular lodging facility, a restaurant or other food and beverage outlet, or a visitor attraction compared to an aggregate of similar lodging facilities, restaurants, or visitor attractions.

### BRIEF SUMMARY OF THE INVENTION

The present invention is a hospitality performance system for comparing a subject hospitality facility's past performance with other similar facilities in its competitive set, and forecasting future performance of the subject facility. The performance system also allows the region's member destination marketing organizations, or convention and visitor bureaus, information they can use to assess the performance of the hospitality and tourism industry in their region (including low demand periods). The performance system of the present invention can be used to produce: 1) last week performance reports, including average daily rates and occupancy; 2) monthly forecast comparisons; 3) historical reports; and 4) trend analysis.

The present invention includes a method for evaluating and forecasting performance at a subject hospitality facility from among a number of hospitality facilities belonging to a hospitality performance system. The method includes the steps of:
(1) transmitting by each subject facility of the plurality of hospitality facilities of performance data of the subject hospitality facility to a central service of the hospitality performance system using an Internet browser to access a website of the hospitality performance system, the system central service being in communication with each of the plurality of hospitality facilities;
(2) analyzing performance data submitted by the plurality of hospitality facilities by the central service of the hospitality performance system; and
(3) storing the performance analyses using permanent storage; wherein the performance analyses are retrievable anytime by the subject hospitality facility. The system central service is in communication with each of the hospitality facilities. Step (1) preferably further includes: (a) using a personal computer and a pre-assigned password to log onto the system website of the hospitality performance system; (b) accessing a weekly questionnaire from the system website using the Internet browser; (c) completing the weekly questionnaire using the personal computer; (d) submitting the completed weekly questionnaire to the system website.

The user-friendly, Internet-based system and method of the present invention provides the user, normally the owner or operator of a subject facility (can also be called a “property”), with a system and method for evaluating the performance of the subject facility as compared to an aggregate of similar facilities in the same region. The operator can select from a variety of performance matrices to make the comparison. The subject facility may be a lodging facility, such as a hotel or motel, a restaurant or other food and beverage outlet, a visitor attraction, or the like.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a basic block diagram of a hospitality performance system according to the present invention;

FIG. 2 is a basic block diagram of a hospitality performance method according to the present invention;

FIG. 3 is a basic block diagram of report functions of a hospitality performance system according to the present invention, for commercial lodging;

FIG. 4 is a basic block diagram of report functions of a hospitality performance system according to the present invention, for visitor attractions;

FIG. 5 is a basic block diagram of report functions of a hospitality performance system according to the present invention, for a restaurant or other food and beverage outlet;

FIG. 6 is an illustrative example of a “last week” report of a hospitality performance system/method in accordance with the present invention;

FIG. 7 is an illustrative example of a hospitality performance system/method historical report in accordance with the present invention;

FIG. 8 is an illustrative example of a hospitality performance index weekly report for a hotel generated in accordance with the present invention;

FIG. 9 is an illustrative example of a hospitality performance system/method “twelve months out” forecast report for a full service hotel generated in accordance with the present invention;

FIG. 10 is an illustrative example of a hospitality performance system/method 52-week chart for a hotel generated in accordance with the present invention;

FIG. 11 is a basic block diagram of a hospitality performance method according to the present invention;

FIG. 12 is an illustrative example of a hospitality performance system/method food service operation questionnaire in accordance with the present invention;

FIG. 13 is an illustrative example of a food service operation questionnaire of the hospitality performance system/method of FIG. 12, pertaining to service type segmentation;

FIG. 14 is an illustrative example of a hospitality performance system/method weekly report for a restaurant generated in accordance with the present invention;

FIG. 15 is an illustrative example of a hospitality performance system/method weekly ticket sales report for an attraction in accordance with the present invention;

FIG. 16 is an illustrative example of a hospitality performance index last week performance report for an attraction in accordance with the present invention;

FIGS. 17 and 18 are illustrative examples of a hospitality performance system/method last week performance report for a restaurant generated in accordance with the present invention;

FIG. 19 is an illustrative example of a hospitality performance system/method history for a restaurant generated in accordance with the present invention; and

FIGS. 20 and 21 are an illustrative example of a hospitality performance system/method forecast report for a hotel generated in accordance with the present invention.

### DETAILED DESCRIPTION OF THE INVENTION

In the following description, like reference characters designate like or corresponding parts throughout the several views. Referring in more detail to the drawings, the invention will now be described.

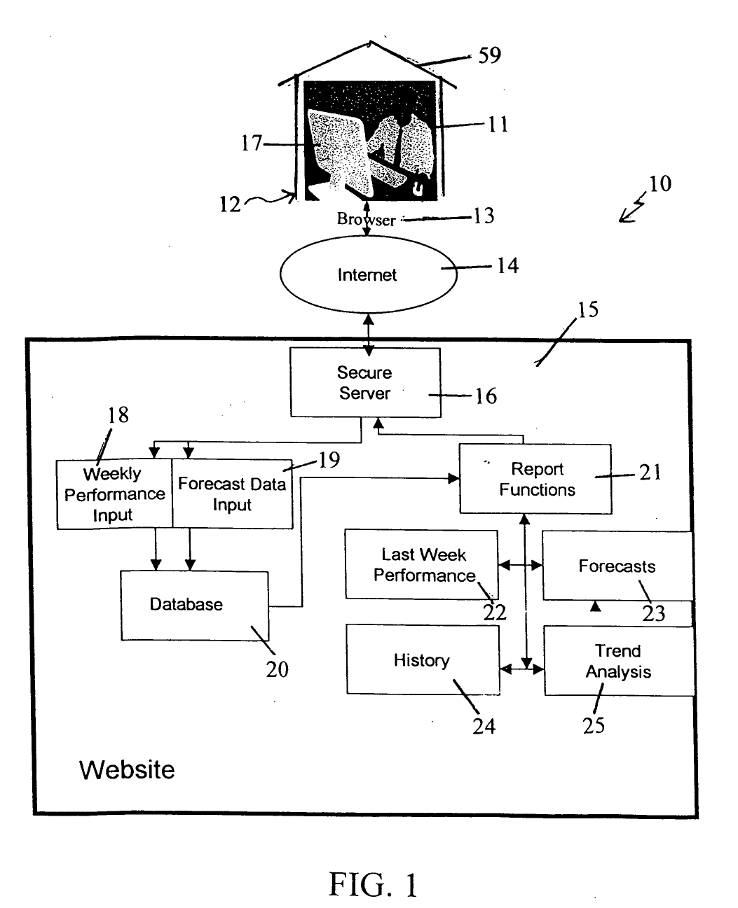

Turning first to the overview depicted in FIG. 1, a typical hospitality performance system 10 according to the present invention involves a system user 11 at a remote location with a personal computer 12 accessing a website 15 on the Internet 14 via a secure server 16. The secure web server 16 supplies wide area network communications to the personal computer 12 through the Internet. The personal computer 12 has a computer monitor 17 and a commercially available browser 13 for viewing the Internet website 14 on the computer monitor 17. The Internet permits rapid access to the present hospitality performance system 24 hours a day, 7 days a week. It also permits many system users to access the hospitality performance system 10 simultaneously.

The system questionnaires are accessed by the user's personal computer 12 from the system website 14 via the user's web browser linked to the secure server. The system user then fills in the desired system questionnaires and returns them to the system website 14 utilizing the user's personal computer 12. Information from the inputted questionnaires is stored on the secure server for future analysis by the user once the system administrator 26 activates the report function for the week. This occurs when the system administrator 26 has viewed the raw data and ensured that a sufficient number of properties (facilities) have reported and that there are no unusual data entry errors. Permanent storage allows the raw inputted data to be stored for future retrieval and analysis through the system's pre-programmed analysis options. Customized reports may be produced and printed out on the user's printer for whatever time period has been requested by the user.

The reports are customized; the performance of the system user's own hospitality facility 59 is not included in the aggregates of other properties, or facilities, against which the subject facility 59 is benchmarked. In the hospitality performance system 10, data from at least three other hospitality facilities, or domains, in the selected segment must be available for the time period in order for the performance system 10 to produce an aggregate performance measure. This is to ensure that the performance of an individual facility will not be revealed to competitors. It provides the owner or manager of the facility with a better sense of how the overall market is going, so that he or she can make better informed decisions.

The hospitality facility 59 is called a subject facility, property, or firm herein. The hospitality performance system 10 is suitable for use in connection with the following subject facilities: hotels, motels, bed and breakfast establishments, rental villas, rental beach homes; fun parks, arcades, nature preserves, historical attractions; full-service restaurants, limited service restaurants, hotel restaurants, fast food restaurants, delivery services, cafeterias, etc.

With continued attention to FIG. 1, user generated weekly performance input 18 and forecast data input 19 are submitted to the database 20. The database 20 outputs report functions 21. Report functions 21 are derived from last week's performance 22, forecasts 23, historical performance 24, and trend analysis 25. The user accesses report functions via the secure server 16.

The hospitality performance system 10 includes:

(a) an Internet-based data collection function for collecting data from a subject facility;

(b) a centralized database on a secure server; and

(c) a querying function for querying the centralized database and creating customized performance reports containing information collected by the hospitality performance system's data collection function;

wherein the hospitality performance system produces at least one of the performance reports for the subject facility. A performance report is useful for benchmarking the user's facility's past and future performance in the particular competitive marketplace.

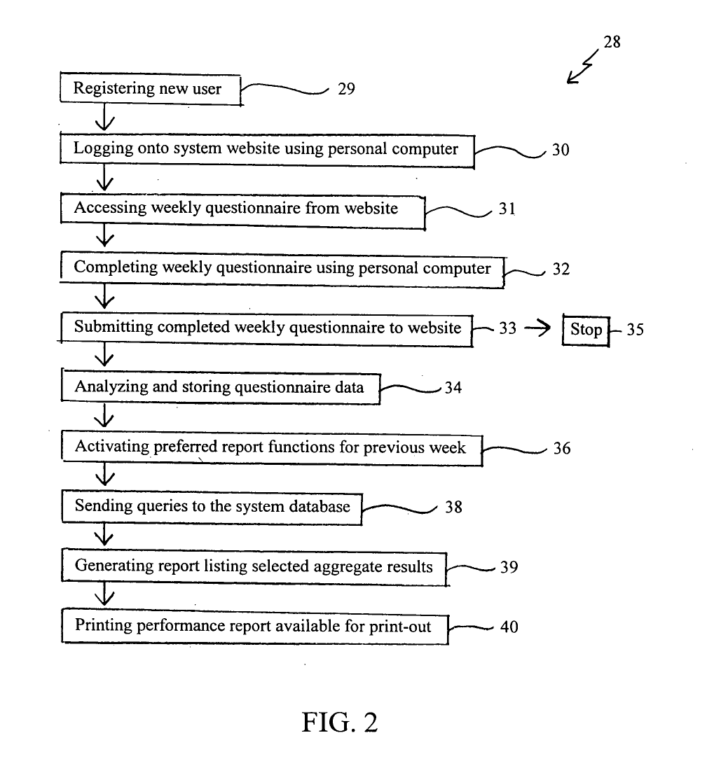

As shown in the preferred embodiment of FIG. 2, the business method 28 preferably incorporates the use of a central service 15a with a system administrator 26. The system administrator 26 communicates with the system users 11 through a network, normally the Internet 14. The system administrator 26 can view the performance system 10 on a daily basis. The system administrator 26 determines which users have submitted data for the week and which have not. In addition, the system administrator 26 can view raw inputted data to determine whether users have inputted incorrect data into the system, such as 250% occupancy for particular week instead of 25%.

All data transferred on the performance system 10 is encrypted by the central service's secure server 16 for security purposes. The server 16 runs up-to-date antivirus software. Vulnerability assessments are run on a regular basis to check for security problems. Historical data in the hospitality performance system 10 is preferably backed up to ensure future access.

Referring to the overview provided in FIG. 2, the method 28 for evaluating and forecasting performance at a subject hospitality facility 59 from among a number of hospitality facilities belonging to the hospitality performance system 10 includes the following steps:
(1) transmitting by each subject hospitality facility 59 of its performance data to a central service 15a of the hospitality performance system 10 using an Internet browser 13 to access a website 15 of the hospitality performance system 10, the system central service 15a being in communication with each of the system hospitality facilities 59;
(2) analyzing performance data submitted by the system hospitality facilities 59 using the central service 15a of the hospitality performance system 10; and
(3) storing the performance analyses using permanent storage; wherein the performance analyses are retrievable anytime by the subject hospitality facility 59. The system user at a subject hospitality facility can access the stored data using pre-programmed queries to the system database and then print out customized performance reports.

Referring to the overview provided in FIG. 2, a method 28 of interacting with the performance system 10 includes the following:

1. For joining the hospitality performance system 10, the method 28 includes registering each new hospitality facility, and at least one potential user at the new hospitality facility, as depicted in Block 29, including the steps of:
(a1) inputting the name or names of the user(s) 11 at the new hospitality facility 59, the name and location of the facility (commercial lodging, good and beverage outlet, or attraction), and other information as desired; and
(b1) assigning each system user 11 a user name and password for the hospitality performance system 10. The system user may stop after this step, if desired.

2. Once the system user is registered with the hospitality performance system 10, the method 28 of interacting with the hospitality performance system 10 includes the steps of:
a) using a personal computer (PC) 12 and the pre-assigned password to log onto the system website 15 of the hospitality performance system 10, as shown in Block 30;
b) accessing a weekly questionnaire from the system website 15 using the Internet browser 13, as depicted in Block 31;
c) completing the weekly questionnaire using the personal computer, as depicted in Block 32;
d) submitting completed weekly questionnaire to the system website 15, as depicted in Block 33; and
e) analyzing and storing questionnaire data using permanent storage, as depicted in Block 34. The system user may stop at step (d), as depicted in Block 35, if desired. The system is programmed using a software database program to calculate various aggregate results based on pre-programmed formulas and the raw questionnaire data inputted by the system users 11 to the system website 15.

Once the user has access to the performance system 10, a method of using the hospitality performance system 10 to generate a performance report includes the steps of:
a) activating the preferred report functions for the previous week at the performance system's central service 15a (by the system administrator), as depicted in Block 36;
b) sending queries to the system database, as depicted in Block 38;
c) generating at least one performance report itemizing the aggregate results for the competitive set for the subject facility (by the system user), as depicted in Block 39; and
d) making the performance report available for print-out using the personal computer at the subject hospitality facility 59, as depicted in Block 40. The performance report can be used to benchmark the subject facility's performance against its competitive set, etc. The system user may stop at this point.

Once the system member is registered, several security measures are undertaken. The facility administrator 27 appointed by the system member receives a login name and a security password that allows the facility administrator 27 computer access to the hospitality performance system 10. There are two classifications of facility users for whom the facility can request login names: a) those with access to reporting functions (“other users”); and b) those with responsibility for entering the facility data on a weekly basis (facility administrators). Facility administrators 27 have access to system report functions. It has been found herein that the hospitality performance system 10 works better if only the facility administrator 27 and other facility users who have been assigned a login name and password are permitted to view system data. Preferably, each facility user is assigned an account instead of having multiple users with the same login name and password. This is advantageous in that it avoids problems when an employee leaves employment at the facility, for example.

The hospitality performance system 10 is flexible in that one person from a subject facility 59 can report on multiple business units (e.g., hotels, restaurants) of the subject facility, if desired. The hospitality performance system 10 is also flexible in that facility administrators 27 and other users can be restricted in the report functions 21 to specific business units, or, if desired, all of the business units of the facility that the hospitality performance system tracks.

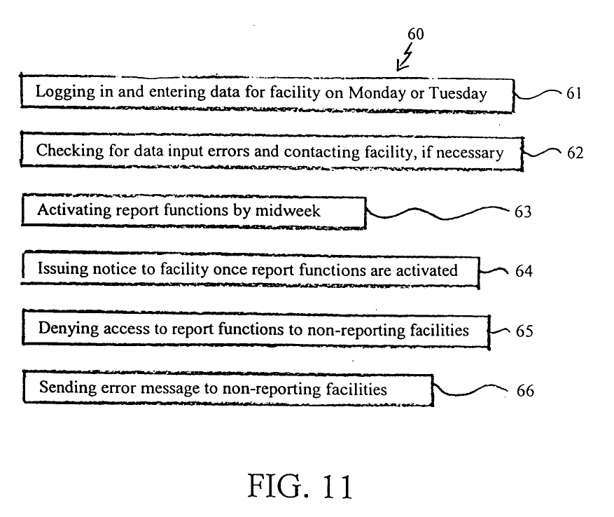

Referring to FIG. 11, the method 28 of using the hospitality performance system 10 further includes the following weekly steps 60, which are preferably undertaken on a weekly basis.
1. Logging in and entering performance data for the subject facility 59 at the beginning of every week (preferably on Monday or Tuesday), as depicted in Block 61. This includes entering all fields with numeric values on the system data entry form/questionnaire. It has been found herein that failure to do so can skew the system computations. For example, where the subject facility 59 has no group demand for a particular day, a ‘0’ should be entered instead of leaving the input cell blank. The system administrator monitors data entry by system users.
2. Checking for data input errors and, if an error is present, contacting the facility administrator 27 to correct such errors, as depicted in Block 62.
3. Activating report functions by midweek, preferably on every Wednesday morning, as depicted in Block 63. These first three tasks, 1-3, are preferably accomplished by the facility administrator 27.
4. Issuing a notice by email to the facility administrator 27 notifying the facility administrator once the report functions have been activated by the system administrator 26, as depicted in Block 64. This is automatically done by the hospitality performance system 10.
5. Denying access to report functions to querying users from non-reporting member facilities for which no data has been submitted during the week in question, as depicted in Block 65.
6. Sending an error message to the non-reporting facility administrator indicating that data from the subject facility 59 has not been received by the hospitality performance system 10, as depicted in Block 66. This is automatically done by the hospitality performance system 10, if there is a non-reporting facility.

In order to have access to the report functions of the hospitality performance system 10, the subject facility 59 must submit performance data on a weekly basis. Where the subject facility 59 is a hotel, motel, or other lodging facility, the method 28 further comprises the steps of:
1. Prompting a subject facility to provide measures of the previous (last) week's performance (Monday through Sunday) at the subject facility. Such measures preferably include the following: a) Number of rooms available (the number of physical rooms available, but not room nights for the week); b) Average room rate for the previous week; c) Transient room nights sold for the previous week, but not complimentary rooms; and d) Group room nights sold for the previous week, but not complimentary rooms.
2. Prompting the subject facility to provide projected demand for the next four weeks by day. Such projected demand preferably includes: a) Transient demand (forecasted); and b) Group demand (actual bookings).
3. Where the subject facility is a full service hotel, prompting the subject facility user to provide confirmed group books by day for the month in question a year from the time of reporting.

Once data has been submitted and the report function is activated on Wednesday, authorized users of the subject facility 59 may login to the hospitality performance system 10 at their convenience and generate the following performance reports, as desired:
1. Last Week's Performance Report, a comparison of the subject facility's performance in average daily rate (ADR), revenue per available room (RevPar), and Occupancy according to competitive sets. Competitive sets are preferably classified by Segment, Rate, Location, and Location Type.
2. Forecast Report, a comparison of the subject facility's forecasted occupancy rates (e.g., transient, group, total) for the next four weeks by day according to competitive set (e.g., Segment, Rate, Location, and Location Type).
3. Group Pickup Report, as a percentage of occupancy, by hotel location; where the subject facility is a full service hotel; and wherein the subject hotel is compared to a competitive set of hotels (an aggregate of similar properties in the subject market).

The ADR (average daily rate) is the average price of each room sold. The daily, weekly, and/or monthly ADR can be calculated, for example. Occupancy (normally expressed as % occupancy) can be calculated by dividing the number of rooms available into the number of rooms sold. RevPar, or Revenue per Available Room, can be calculated in various ways over a desired time period (e.g., weekly, monthly, or quarterly). For example, the amount of revenue for a hotel room can be divided by the number of rooms available in the hotel to calculate RevPar. Alternatively, the ADR multiplied times the % Occupancy can be used to calculate RevPar.

The subject property's performance numbers are not aggregated in the competitive set(s) selected. Thus, the subject property's performance stands in contrast to the competitive set. There will likely be rounding errors in the sums of the selected competitive set's forecasted occupancies (i.e., transient forecast+group forecast=total forecasts). The software calculates averages of averages as compared to summing all rooms' nights and occupancies for the competitive set. This is considered to be a better reflection of the competitive set.

The hospitality performance system 10 is programmed so that at least three reporting properties must be included in the selected competitive set in order to ensure confidentiality of the individual reporting properties, or facilities. If less than three properties report in a particular week, the performance system 10 will not generate performance reports for that competitive set. In such cases, the report will state “NA” for “not available”, or generate an error report. If an error report is received, the performance system 10 allows the system user 11 to hit the back button on the personal computer keyboard, thus eliminating a criterion of the selected competitive set, hopefully to a point where there is a sufficient number of system properties reporting.

Once there is sufficient data in the hospitality performance system 10, the system permits the system user 11 to retrieve past weekly historical data for the subject property 59 and the user's choice of competitive sets, preferably by clicking on “View Histories”. For example, a category called “occupancy rate, RevPar, and ADR of hotels in Smithville next week a year ago” can be recalled by simply typing in the dates in question. The system user 11 defines the week in question by inputting month, days, and years in order to generate the requested reports. If an error is made in the input, the performance system 10 generates an error message to indicate the required format to the system user.

The hospitality performance system 10 may also include: (a) a system restaurant index (showing covers, and turns by segments including those in lodging facilities); and (b) a system visitor attraction index, which indicates, among other things, numbers of walk ups and groups.

The hospitality performance system 10 provides a comparison of a subject facility's past performance with other similar facilities in its competitive set, and permits the prediction of future performance of the subject facility. The hospitality performance system 10 can be used to produce: 1) last week performance reports, including average daily rates and occupancy; 2) monthly forecast comparison; 3) historical report; and 4) trend analysis. The hospitality performance system 10 can also supply the region's destination marketing organizations, or convention and visitor bureaus, with information they can use to assess the performance of the hospitality and tourism industry in their region, including low demand periods.

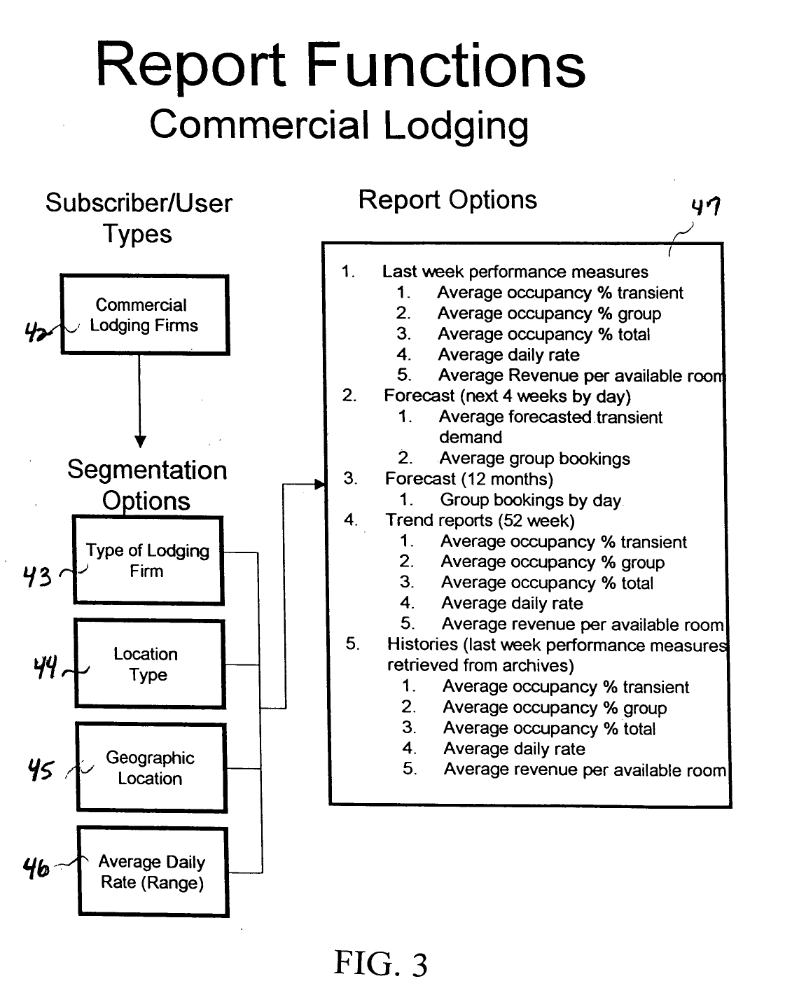

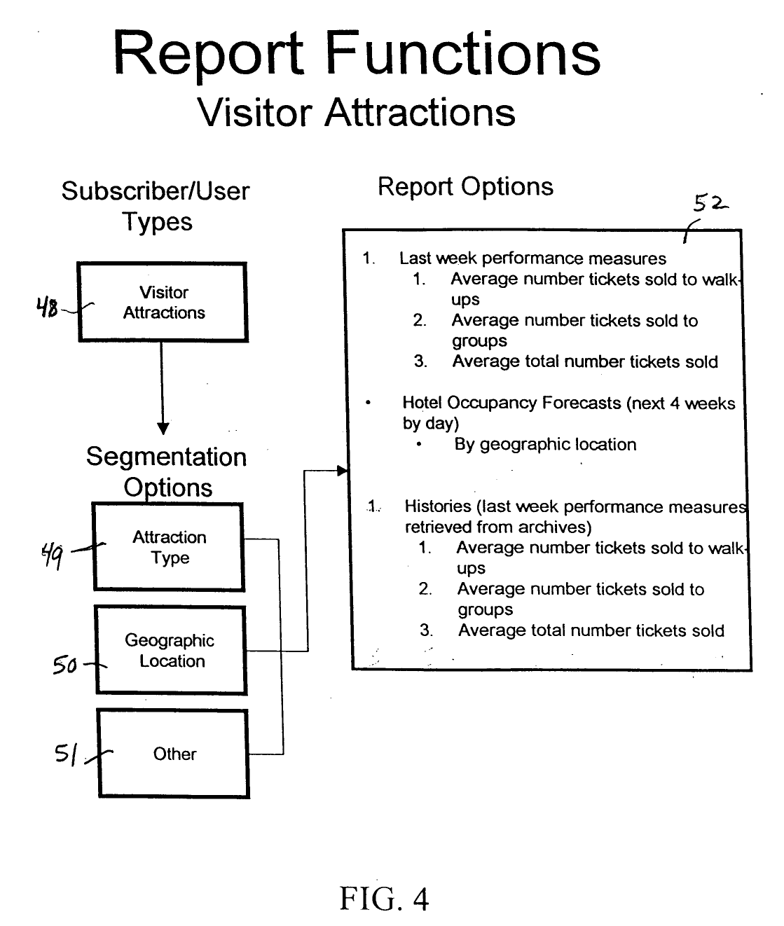

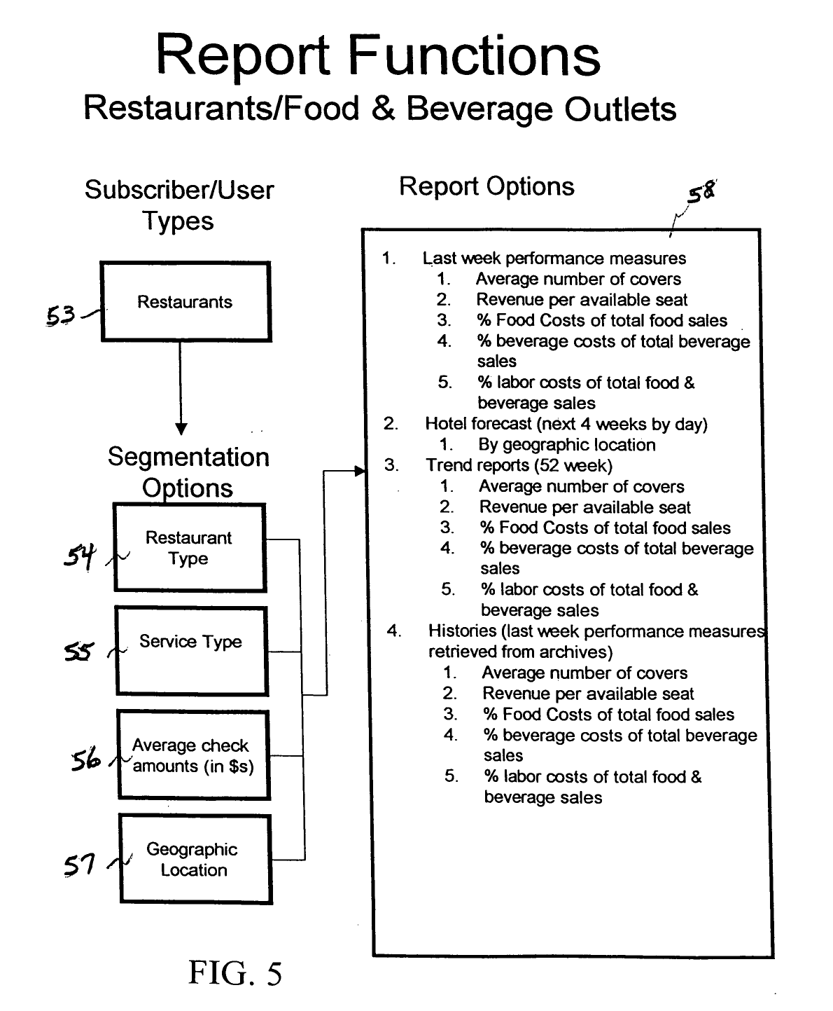

Report functions 21 of the hospitality performance system 10 for commercial lodging facilities 42 are depicted in FIG. 3, report functions for visitor attractions 48 are found in FIG. 4, and report functions for restaurants 53 and other food and beverage outlets are found in FIG. 5. When the user logs on, for example, he or she can select from a user menu including the following: Attractions, Hotels, Restaurants, or Logout.

Suitable commercial lodging facilities 42 for inclusion in this hospitality performance system 10 are hotels, motels, bed and breakfast establishments, rental villas, rental beach homes, and the like. Visitor attractions 48 suitable for inclusion in the hospitality performance system 10 are fun parks, arcades, nature preserves, historical attractions, and the like. Suitable restaurants 53 and other food service operations for this hospitality performance system 10 include: full-service restaurants with wait staff and payment after consumption of the meal; limited service restaurants without wait staff and payment prior to consumption of the meal, hotel restaurants where the restaurant is located within the hotel property, fast food restaurants, delivery services with consistent limited service that is not limited to delivery to a patron's dwelling, such as a pizza delivery service; cafeterias and other buffet services with a cafeteria line and payment prior to consumption of the meal.

With the present hospitality performance system and method, the system user can also request combinations of information for two or all three of the exemplary categories shown here. For example, the member facility may be a hotel with a restaurant and the system user may request lodging and restaurant reports.

Where the subscriber or user type is a commercial lodging facility 42 or firm (see FIG. 3), segmentation options include: a) type of lodging facility 43; b) location type 44; c) geographic location 45; and d) average daily rate 46 (range). As displayed in Block 47, report options for commercial lodging facilities 42 include the following: 1) last week performance measures; 2) forecast for the next four weeks by day, including average forecasted transient demand and average group bookings; 3) forecast for twelve months, including group bookings by day; 4) 52 week trend reports; and 5) histories (last week performance measures retrieved from archives). Last week performance measures include: average occupancy percent transient; average occupancy percent group; average occupancy percent total; average daily rate; and average revenue per available room. Trend reports include: average occupancy percent transient; average occupancy percent group; average occupancy percent total; average daily rate; and average revenue per available room. For commercial lodging facilities, histories also include: average occupancy percent transient; average occupancy percent group; average occupancy percent total; average daily rate; and average revenue per available room.

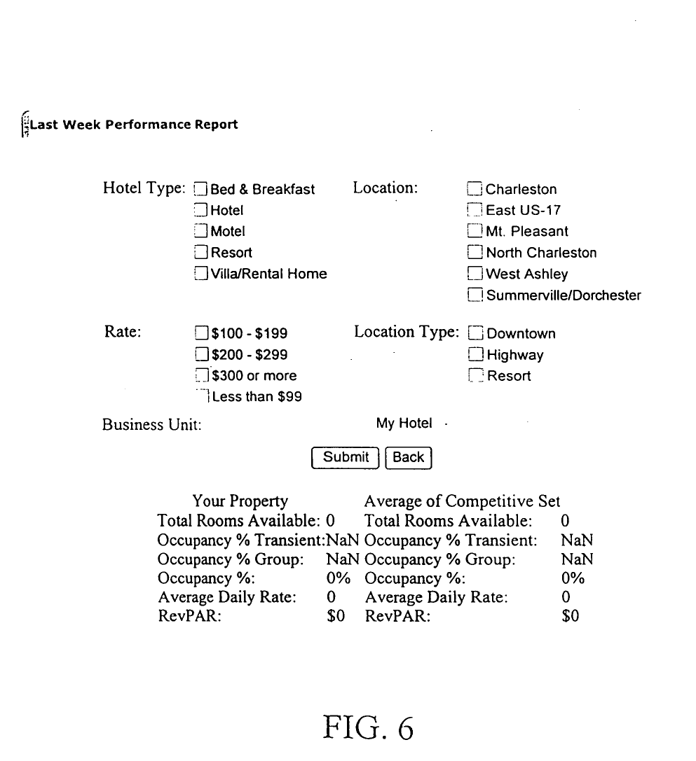

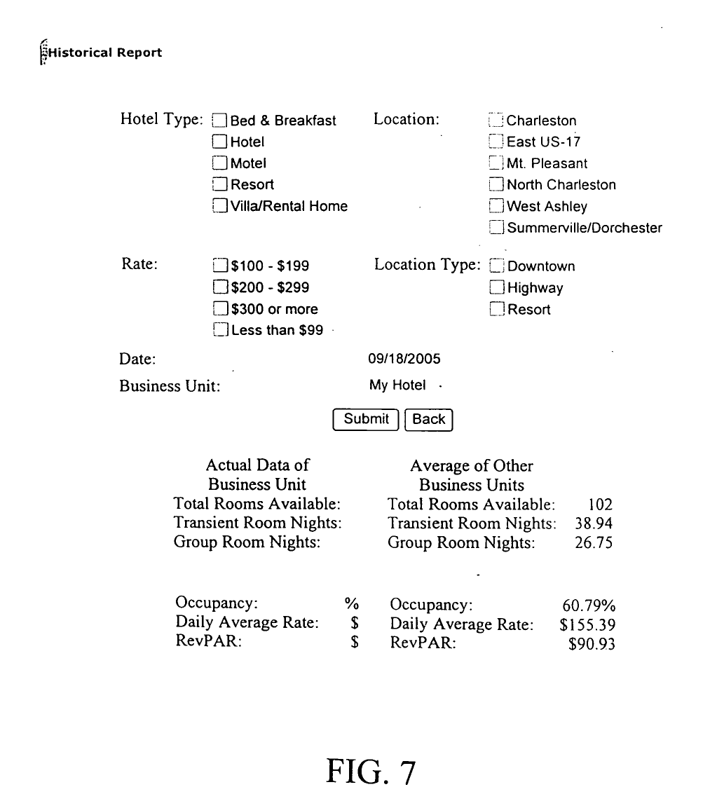

Sample system reports for various lodging facilities are provided in FIGS. 6 through 9. FIG. 6 provides a sample last week performance report for a system user at a lodging facility. A sample historical report generated for a system user at a subject lodging facility is shown in FIG. 7.

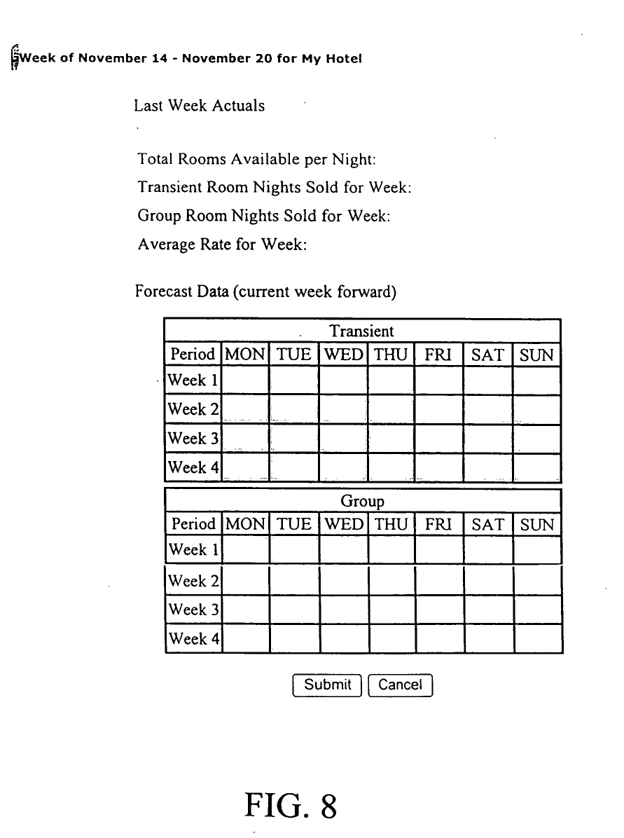

Continuing with lodging facilities, a weekly report form for a hospitality performance system user at a subject hotel lodging facility is shown in FIG. 8. The weekly forecast form shows forecast data for the next four weeks by day, including average forecasted transient demand (“Transient”) and average group bookings (“Group”).

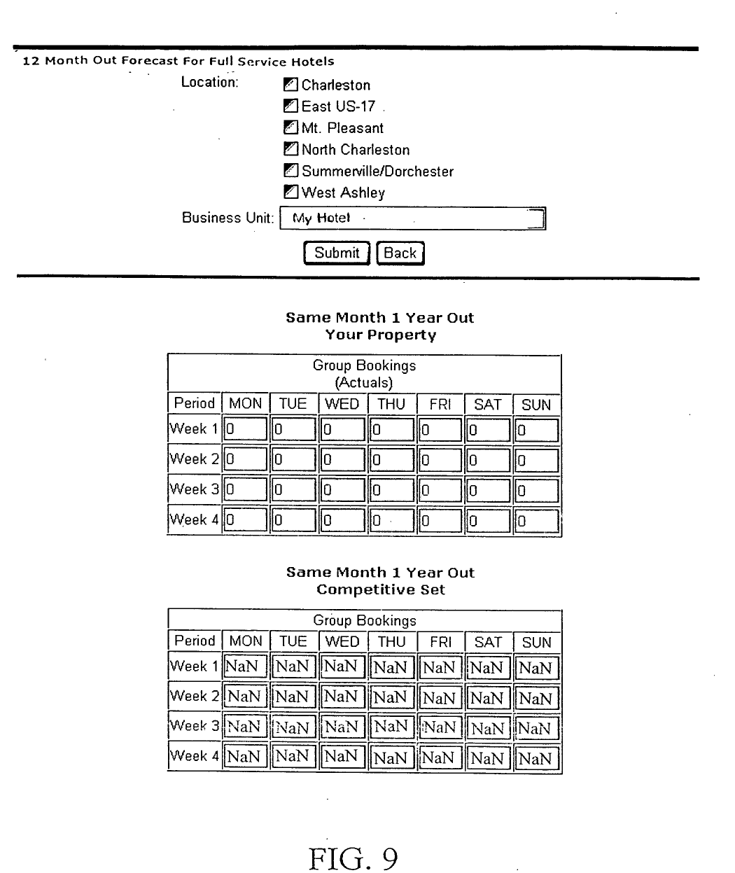

Referring to FIG. 9, a twelve month forecast report form for full service, conference and meetings hotels reveals group bookings for the same month one year from the time the user is on-line. This is particularly useful since meeting planners for conferences and conventions generally book one to two years in advance. The sample report form reveals actual group bookings for the subject facility/property, and group bookings for the competitive set by day for four weeks twelve months out. This allows the facility owner to benchmark his or her performance in securing the segment of group business as compared with that of other similar properties in the region. It also allows the region's destination marketing organization to track their industry's performance and identify low demand periods in which they can sell.

A monthly input data screen for a full-service hotel accessing the hospitality performance system 10 preferably shows actual group bookings for the subject property twelve months from the date the hospitality performance system is being accessed by the system user. Bookings for Weeks 1 through 4, five days a week are inputted.

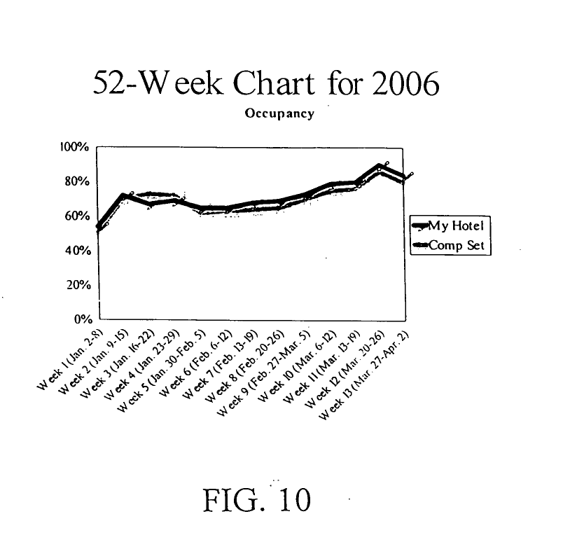

FIG. 10 shows an illustrative 52-week chart for 2006 for occupancy for the subject hotel (dark line) versus the competitive set (lighter line) of other hotels or the like. The facility owner can take this information into account when planning for the following months and year, if he or she so desires.

Referring back to FIG. 4, where the subscriber or user type is a visitor attraction 48, segmentation options include: a) attraction type 49; b) geographic location 50; and c) other options 51. As displayed in Block 52, report options for visitor attractions 48 include the following: 1) last week performance measures; 2) hotel occupancy forecasts for the next four weeks by day, including by geographic location; 3) histories (last week performance measures retrieved from archives). As shown in FIG. 4, performance reports indicating last week performance measures include: average number tickets sold to walk-ups; average number tickets sold to groups; and average total number tickets sold. History reports also preferably indicate: average number tickets sold to walk-ups; average number tickets sold to groups; and average total numbers of tickets sold.

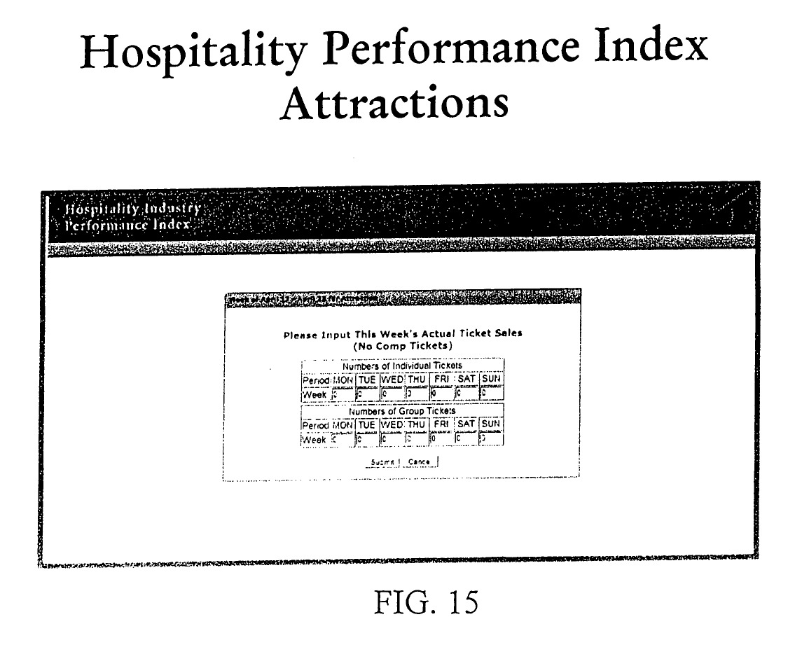

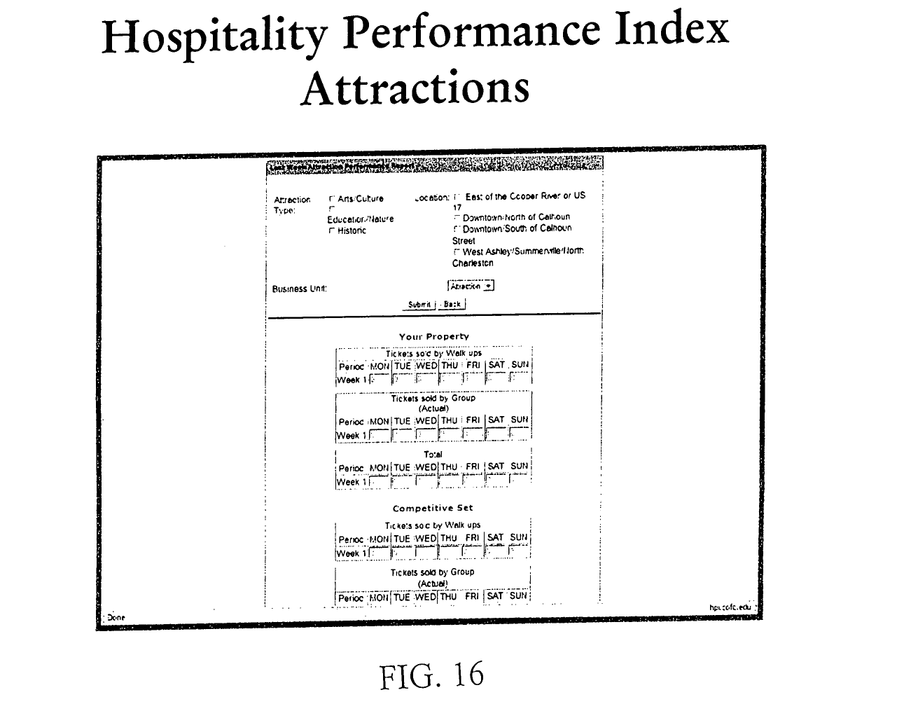

Illustrative examples of an actual ticket sales form and a last week performance report for a visitor attraction 48 are provided in FIGS. 15 and 16, respectively. In the actual ticket sales form shown in FIG. 15, the system user is asked to input numbers of individual tickets and numbers of group tickets for each day of the week. In the last week performance report shown in FIG. 16, the attraction system user inputs the attraction type and location. For example, the last week performance report provides the following selections for “attraction type”: arts/culture; education/nature; or historic. The last week performance report shows the actual number of tickets sold for walk-ups, group, and total for the subject property. The last week attraction report also shows the number of tickets sold for walk-ups and actual group tickets sales for the competitive set.

Continuing with FIG. 5, where the subscriber or user type is a restaurant 53 or other food and beverage outlet, segmentation options include: a) restaurant type 54; b) service type 55; c) average check amounts 56 (preferably in US dollars); and d) geographic location 57. As displayed in Block 58, report options for restaurants 53 and other food and beverage outlets include the following: 1) last week performance measures; 2) hotel forecast for the next four weeks by day, including by geographic location; 3) 52 week trend reports; and 4) histories (last week performance measures retrieved from archives). Reports of last week performance measures include: average number of covers (the number of people in a party); revenue per available seat; percent food costs of total food sales; percent beverage costs of total beverage sales; and percent labor costs of total food and beverage sales. For restaurants 53 and other food and beverage outlets, trend reports and histories each include: average number of covers; revenue per available seat; percent food cost of total food sales; percent beverage costs of total beverage sales; and percent labor costs of total food and beverage sales.

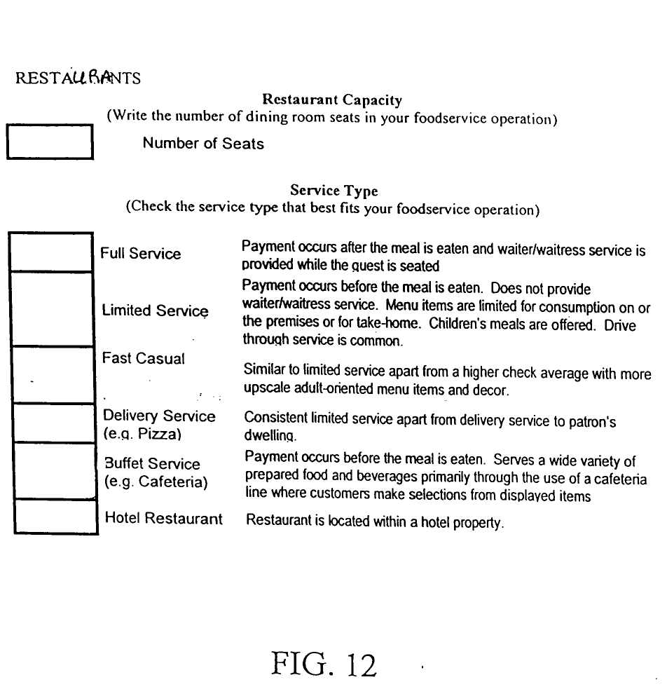

Sample system reports for food service operations are provided in FIGS. 12 through 14. FIG. 12 shows a system sample form for a restaurant 53 or other food and beverage outlet. While the system user 11 is being registered by the system administrator 26, the system user 11 is asked to report the number of dining room seats at the foodservice operation. At this time, the system user 11 is also asked to provide the service type that best describes the subject food service operation from among the following food service operation categories: full-service; limited service; fast casual; delivery service (e.g., pizza); buffet service, such as a cafeteria; or a hotel restaurant.

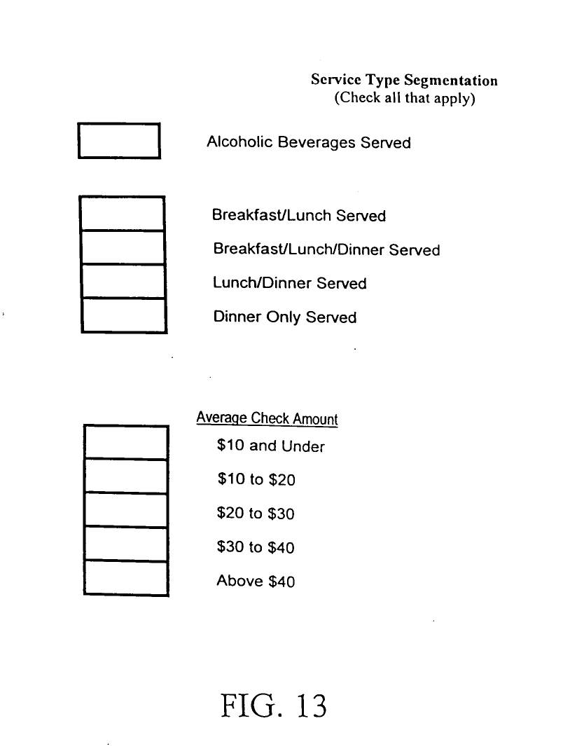

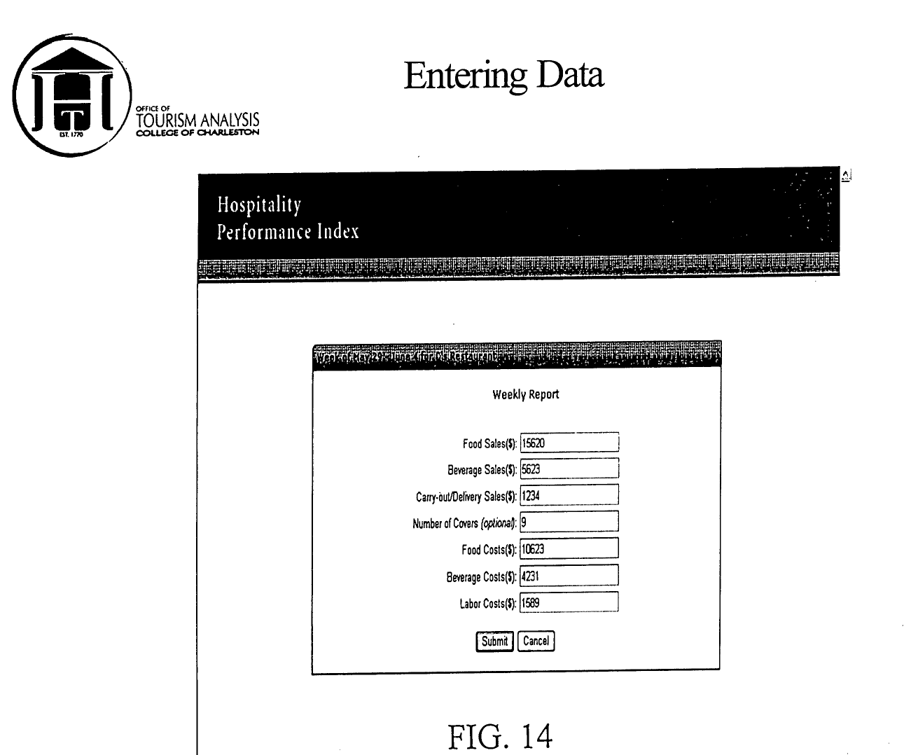

Continuing with restaurants, FIG. 13 shows a service type segmentation system form in which the system user is asked whether alcoholic beverages are served at the restaurant, whether breakfast, lunch, and/or dinner are served at the restaurant, and the average check amount paid by diners at the restaurant. In the weekly report form for a restaurant or other food service shown in FIG. 14, the system user 11 is asked to input food sales, beverage sales, carry out/delivery sales, number of covers (optional), the cost, beverage costs, and labor cost.

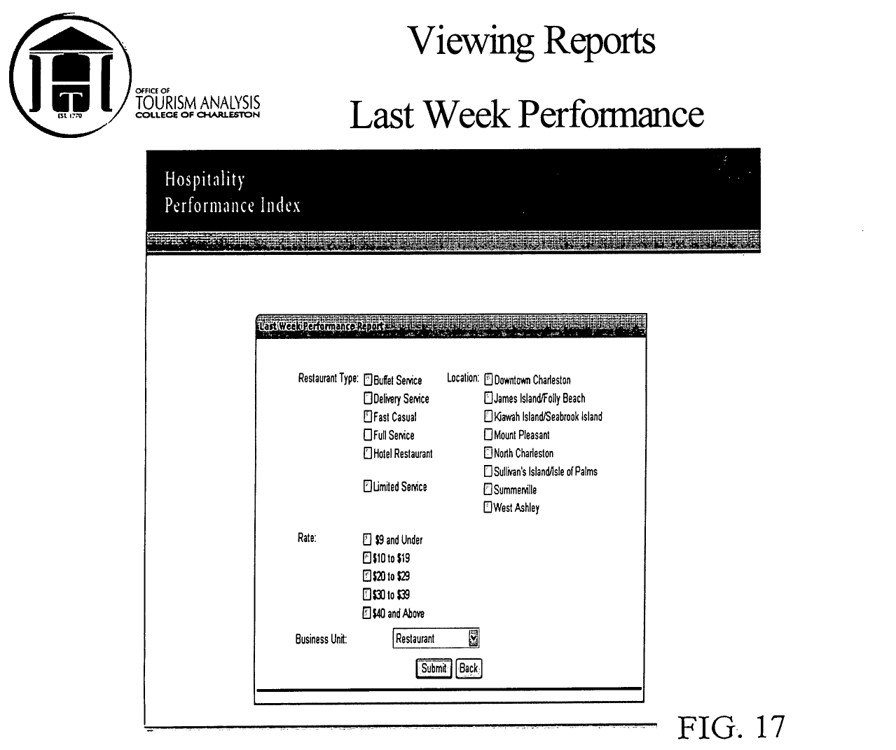

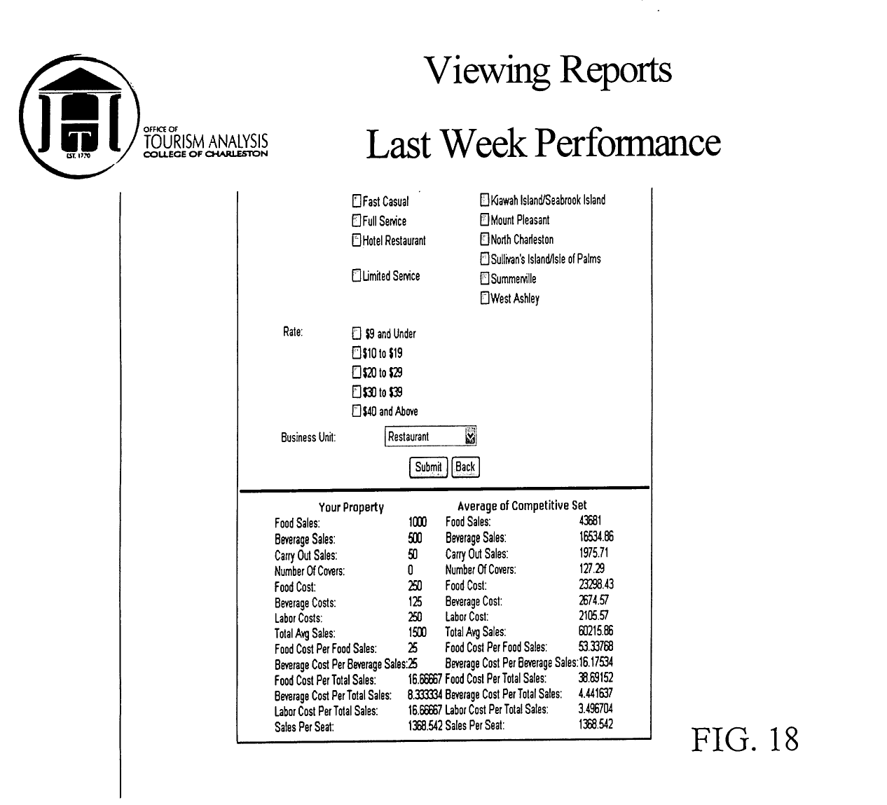

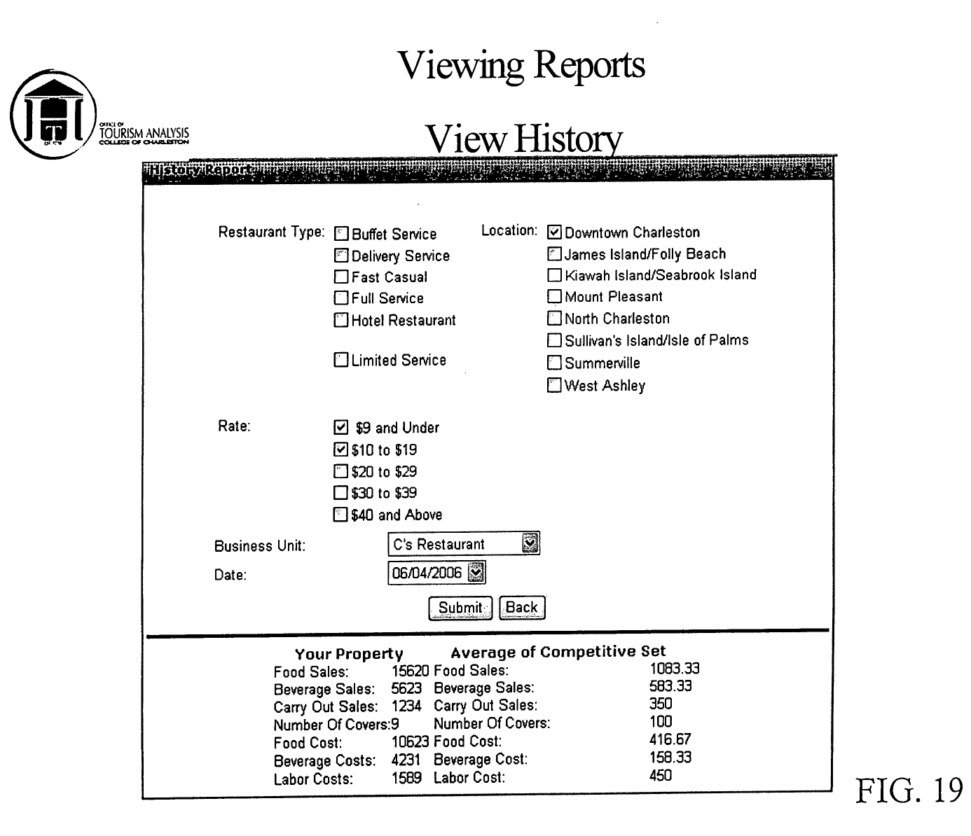

Further in regard to restaurants, FIGS. 17-19 depict exemplary system performance reports for: a last week performance report for a restaurant in FIGS. 17 and 18; and a historical report for a restaurant in FIG. 19. The last week performance report for a subject restaurant in FIG. 18 shows performance parameters of the subject hospitality facility (property) in the left hand column opposite the average for the competitive set in a right hand column of the figure. Performance parameters listed in FIG. 18 include food sales, beverage sales, carry out sales, number of covers, food costs, beverage costs, labor costs, total average sales, food cost per food sales, sales per seat, etc. The historical report for a subject restaurant in FIG. 19 also shows performance parameters of the subject hospitality facility (property) in the left hand column opposite the average for the competitive set in a right hand column of the figure. Performance parameters listed in FIG. 19 include food sales, beverage sales, carry out sales, number of covers, food costs, beverage costs, and labor costs.

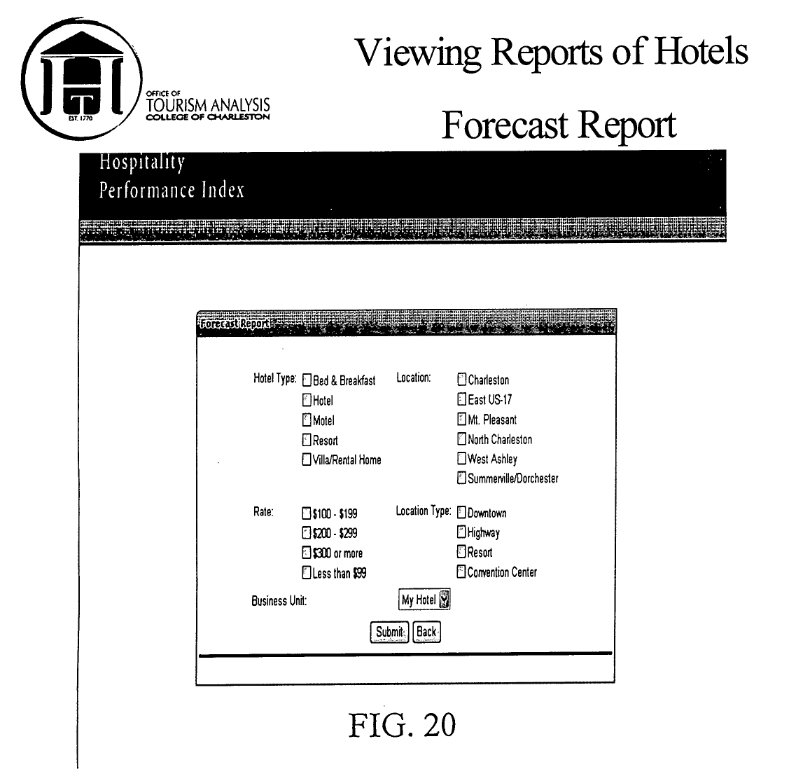

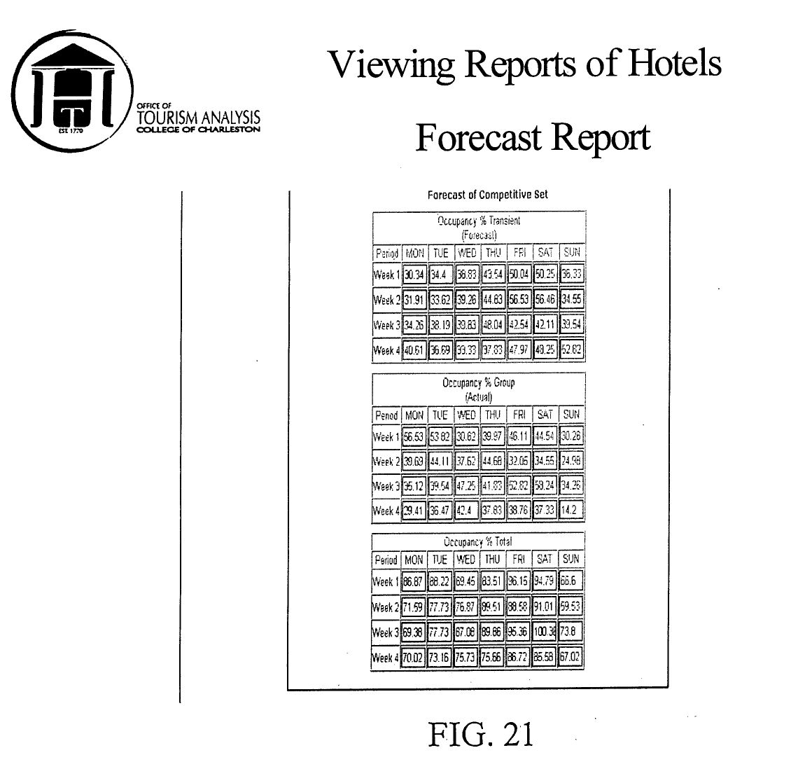

FIGS. 20 and 21 depict an exemplary system forecast report for a hotel. In FIG. 21, the forecast report shows a forecast for the competitive set of hotels, grouped by Occupancy % Transient, Occupancy % Group (actual), and Occupancy % Total for each day of a four week period.

From the foregoing it can be realized that the described system and method of the present invention may be easily and conveniently utilized for assessing performance at a lodging facility, food and beverage outlet, visitor attraction, or the like, comparing recent performance to performance historically at the same hospitality facility, and comparing recent performance at the facility to the performance of an aggregate of hospitality facilities in the same area. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 Hospitality performance index
11 System user
12 Personal computer
13 Browser
14 Internet
15 Website
16 Secure server
17 Computer monitor
18 Weekly performance input
19 Forecast data input
20 Database
21 Report functions
22 Last week performance
23 Forecasts
24 History
25 Trend analysis
26 System administrator
27 Facility administrator
28 Method
29 Registering new user
30 Using PC to log onto website
31 Accessing weekly questionnaire
32 Completing weekly questionnaire
33 Submitting completed weekly questionnaire
34 Analyzing and storing data
35 Member user stop
36 Activating report function for previous week
38 Sending queries
39 Generating report listing aggregate results
40 Printing report
42 Commercial lodging facility
43 Type of lodging facility
44 Location type
45 Geographic location
46 Average daily rate
47 Report options for lodging facilities
48 Visitor attraction
49 Attraction type
50 Geographic location for lodging
51 Other options
52 Report options for attractions
53 Restaurant
54 Restaurant type
55 Service type
56 Average check amounts
57 Geographic location for restaurant
58 Report options for restaurant
59 Hospitality facility
60 Weekly tasks
61 Logging in and entering data for facility
62 Checking for data input errors
63 Activating report functions by midweek
64 Issuing notice to facility
65 Denying access to non-reporting facilities
66 Sending error message to non-reporting facilities

What is claimed is:

1. A method for evaluating and forecasting performance at a subject hospitality facility from among a plurality of hospitality facilities belonging to a hospitality performance system, the method comprising the steps of:
(1) transmitting by each subject hospitality facility of the plurality of hospitality facilities of performance data of the subject hospitality facility to a central service of the hospitality performance system using an Internet browser to access a website of the hospitality performance system, the system central service being in communication with each of the plurality of hospitality facilities;
(2) analyzing performance data submitted by the plurality of hospitality facilities using the central service of the hospitality performance system; and
(3) storing the performance analyses using permanent storage; wherein the performance analyses are retrievable anytime by the subject hospitality facility.

2. The method according to claim 1, wherein step (1) further comprises: (a) using a personal computer and a pre-assigned password to log onto the system website of the hospitality performance system; (b) accessing a weekly questionnaire from the system website using the Internet browser; (c) completing the weekly questionnaire using the personal computer; (d) submitting the completed weekly questionnaire using the system website.

3. The method according to claim 2, wherein step (1) is preceded by steps comprising the steps of:
(a1) registering each new hospitality facility of the hospitality performance system, and at least one potential user at the new hospitality facility, by inputting the name of the at least one potential user from the new hospitality facility, and a name and location of the new hospitality facility; and
(b1) assigning each potential user a user name and password for the hospitality performance system.

4. The method according to claim 2, further comprising the steps of:
(a) activating preferred report functions for the previous week at the central service of the hospitality performance system;
(b) sending queries to the system central service;
(c) generating at least one performance report itemizing aggregate performance analyses for at least one competitive set of the subject hospitality facility; and
(d) making the performance report available for print-out using the personal computer at the subject hospitality facility.

5. The method according to claim 2, further comprising the weekly steps of:
(a) logging in and entering performance data for the subject hospitality facility at the beginning of every week;
(b) checking for data input errors and, if an error is present, contacting a facility administrator of the subject hospitality facility;
(c) activating report functions by midweek; and
(d) issuing a notice by e-mail to the facility administrator once the report functions have been activated.

6. The method according to claim 5, further comprising the steps of:
(e) denying access to report functions to querying system users from non-reporting system hospitality facilities for which no data has been submitted during the previous week; and
(f) sending an error message to the facility administrator at non-reporting hospitality facilities.

7. The method according to claim 2, where the subject facility is a lodging facility, further comprising the steps of:
(1) Prompting a system user at a subject hospitality facility to provide at least one measure of a previous week's performance at the subject hospitality facility; and
(2) Prompting the system user at the subject hospitality facility to provide projected demand for the next four weeks by day.

8. The method according to claim 7, where the lodging facility is a full service hotel, and further comprising the step of:
(3) Prompting the system user at the subject hospitality facility to provide confirmed group books by day for a month in question a year from a time of reporting.

9. The method according to claim 7, wherein the at least one measure of the previous week's performance comprises:
(a) Number of rooms available, but not room nights, for the previous week;
(b) Average room rate for the previous week;
(c) Transient room nights sold the previous week, but not complimentary rooms; and
(d) Group room nights sold the previous week, but not complimentary rooms.

10. The method according to claim 7, wherein the projected demand for the next four weeks by day comprises:
(a) Transient demand (forecasted); and
(b) Group demand.

11. An on-line hospitality performance system for benchmarking a subject hospitality facility's performance in comparison to a selected competitive set, the hospitality performance system comprising:
(a) a centralized database for system users on a secure server;
(b) a first, Internet based data collection sub-system in communication with the centralized database; and
(c) a second, reporting sub-system in communication with the centralized database for querying the centralized database and generating at least one customized performance report;
wherein the hospitality performance system generates at least one of the performance reports for the subject hospitality facility.

12. The system according to claim 11, wherein the hospitality performance system first and second sub-systems are each automated.

13. The system according to claim 11, wherein the at least one performance report comprises:
(1) a Last Week's Performance Report, a comparison of the subject hospitality facility's performance in average daily rate, revenue per available room, and occupancy according to the competitive set; and
(2) a Forecast Report, which is a comparison of forecasted occupancy rates for the subject hospitality facility for the next four weeks according to the competitive set.

14. The system according to claim 13, wherein the at least one performance report further comprises:
(3) an Historical Report showing previous long term performance for the subject hospitality facility from an archive of the hospitality performance system; and
(4) a 52 Week Trend Report based on last week's performance data.

15. The system according to claim 14, wherein the subject hospitality facility is a full service hotel, and wherein the at least one performance report further comprises:
(5) a Group Pickup Report, as a percentage of total occupancy by groups and by hotel location; wherein the subject full service hotel is compared to a competitive set of hotels.

16. The system according to claim 13, wherein the competitive set is classified according to: segment, rate, location, and location type.

17. The system according to claim 11, wherein the hospitality performance system will not generate the performance reports if less than three system hospitality facilities from a competitive set report in a particular week.

18. The system according to claim 11, wherein an error report is generated if less than three facilities from a competitive set report in a particular week.

19. The system according to claim 11, wherein the subject hospitality facility is a visitor attraction.

20. The system according to claim 11, wherein the subject hospitality facility is a food and beverage outlet.
